(19) United States
(12) Patent Application Publication
(10) Pub. No.: US 2010/0321299 A1
(43) Pub. Date: Dec. 23, 2010

(54) SYSTEM AND METHOD FOR KEY LAYOUT AWARE SPELL CHECK

(75) Inventors: Gabriel SHELLEY, Waterloo (CA); Vadim FUX, Waterloo (CA)

Correspondence Address: RIM/FINNEGAN, 901 New York Avenue NW, Washington, DC, 20001, US

(73) Assignee: RESEARCH IN MOTION LIMITED, Waterloo, ON (CA)

(21) Appl. No.: 12/488,893

(22) Filed: Jun. 22, 2009

(51) Int. Cl. G06F 3/02

(52) U.S. Cl. 345/168

(57) ABSTRACT

A system and method are provided for providing one or more prioritized alternative strings for a target string in a text typed on a keyboard. The method comprises: for each key on the keyboard, maintaining an adjacency mapping to each adjacent key; receiving the target string; determining whether the target string requires a correction; and if the target string does not appear in the linguistic database, presenting the one or more prioritized alternative strings, wherein the one or more prioritized alternative strings are prioritized based on the adjacency mapping.

### TECHNICAL FIELD

The present disclosure relates generally to spell checking applications, and more particularly to a system and method for key layout aware spell checking.

### BACKGROUND

Applications which allow user inputted text, such as data processors, email clients and search engines, can include a spell checker which verifies the spelling of words in the inputted text. Typically, a spell checker may operate on individual words or strings entered by the user. In some spell check applications, each string entered by the user may be compared with a list or database of known words, such as a dictionary, to determine if the string represents an acceptable spelling of a known word. If the string is not found in the list or database of known words it may be considered to be an error. In this case, the user may be alerted to the potential error and a list of alternative strings may be presented to the user for selection.

The alternative strings which may be presented to the user by a spell checker when an error has been detected may, for example, be suggestions of known words. Algorithms exist for finding suggested alternative strings. For example, some suggestion algorithms may suggest known words having a small Levenshtein distance from the inputted string. Other algorithms may maintain a list of common misspellings of known words. If the inputted string represents a common misspelling of a known word, the known word may be suggested to the user as an alternative string.

### BRIEF DESCRIPTION OF THE DRAWINGS

Reference will now be made to the drawings, which show by way of example, embodiments of the present disclosure, and in which:

FIG. 1 shows in block diagram form a portable electronic device according to one example;

FIG. 2 is a front view of an example portable electronic device in a portrait orientation;

FIG. 3 is a simplified sectional side view of the portable electronic device of FIG. 2 (not to scale), with a switch shown in a rest position;

FIG. 4 is a block diagram of the contents of a memory of the portable electronic device of FIG. 2;

FIG. 5 shows in flowchart form a method of creating an adjacency mapping in accordance with one example embodiment;

FIG. 6 shows in flowchart form a method of presenting a prioritized list of alternative strings in accordance with one example embodiment;

FIG. 7A is a top view of a portion of an example keyboard configuration in accordance with one embodiment;

FIG. 7B is a portion of an example key layout mapping in accordance with one embodiment; and

FIG. 7C is a portion of a second example key layout mapping in accordance with one embodiment.

It will be noted that throughout the appended drawings, like features are identified by like reference numerals.

### DETAILED DESCRIPTION

In one aspect, the present application provides a system comprising: a processor for controlling operation of the system; a memory coupled to the processor; at least one output device coupled to the processor; and a keyboard configured to provide input to the processor for receiving a target string. The processor includes one or more modules for providing one or more prioritized alternative strings for a target string, the one or more modules being configured to cause the processor to: maintain an adjacency mapping for each key on the keyboard to each adjacent key; determine whether a correction is recommended for the target string; and if a correction is recommended for the target string, present the one or more prioritized alternative strings on the at least one output device, wherein the one or more prioritized alternative strings are prioritized based on the adjacency mapping.

In another aspect, the present application provides method of providing one or more prioritized alternative strings for a target string in a text inputted by a keyboard, the method comprising: maintaining an adjacency mapping for each key on the keyboard to each adjacent key; receiving the target string; determining whether a correction is recommended for the target string; and if a correction is recommended for the target string, presenting the one or more prioritized alternative strings, wherein the one or more prioritized alternative strings are prioritized based on the adjacency mapping.

Other aspects of the present application will be apparent to those of ordinary skill in the art from a review of the following detailed description in conjunction with the drawings.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. A person skilled in the art would understand that variations and modifications, both those currently known and those that may be later developed, are possible within the scope of the disclosure. Also, the description is not to be considered as limiting the scope of the embodiments described herein.

The embodiments described herein generally relate to an electronic device including a physical or virtual keyboard. Such electronic devices may in particular be portable electronic devices, including communication devices. Examples of portable electronic devices include mobile, or handheld, wireless communication devices such as pagers, cellular phones, cellular smart-phones, wireless organizers, personal digital assistants, wirelessly enabled notebook computers and the like.

The portable electronic device may be a two-way communication device with advanced data communication capabilities including the capability to communicate with other portable electronic devices or computer systems through a network of transceiver stations. The portable electronic device may also have the capability to allow voice communication. Depending on the functionality provided by the portable electronic device, it may be referred to as a data messaging device, a two-way pager, a cellular telephone with data messaging capabilities, a wireless Internet appliance, or a data communication device (with or without telephony capabilities). The portable electronic device may also be a portable device without wireless communication capabilities as a handheld electronic game device, digital photograph album, digital camera and the like.

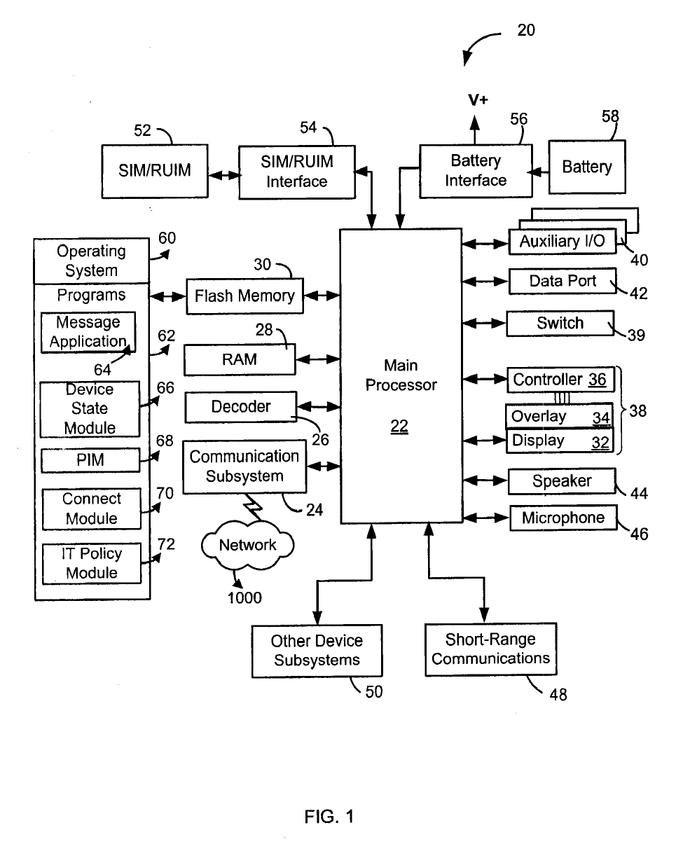

Referring first to FIG. 1, there is shown therein a block diagram of an exemplary embodiment of a portable electronic device 20. The portable electronic device 20 includes a number of components such as the main processor 22 that controls the overall operation of the portable electronic device 20. Communication functions, including data and voice communications, are performed through a communication subsystem 24. Data received by the portable electronic device 20 can be decompressed and decrypted by a decoder 26, operating according to any suitable decompression techniques (e.g. YK decompression, and other known techniques) and encryption techniques (e.g. using an encryption technique such as Data Encryption Standard (DES), Triple DES, or Advanced Encryption Standard (AES)). The communication subsystem 24 may receive messages from and send messages to a wireless network 1000. In this exemplary embodiment of the portable electronic device 20, the communication subsystem 24 may be configured in accordance with the Global System for Mobile Communication (GSM) and General Packet Radio Services (GPRS) standards. The GSM/GPRS wireless network is used worldwide. New standards such as Enhanced Data GSM Environment (EDGE) and Universal Mobile Telecommunications Service (UMTS) are believed to have similarities to the network behavior described herein, and it will also be understood by persons skilled in the art that the embodiments described herein may use any other suitable standards that are developed in the future. The wireless link connecting the communication subsystem 24 with the wireless network 1000 may represent one or more different Radio Frequency (RF) channels, operating according to defined protocols specified for GSM/GPRS communications. With newer network protocols, these channels may be capable of supporting both circuit switched voice communications and packet switched data communications.

Although the wireless network 1000 associated with the portable electronic device 20 may be a GSM/GPRS wireless network in one exemplary implementation, other wireless networks may also be associated with the portable electronic device 20 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA1000 networks, GSM/GPRS networks (as mentioned above), and future third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems. The main processor 22 may also interact with additional subsystems such as a Random Access Memory (RAM) 28, a flash memory 30, a display 32 with a touch-sensitive overlay 34 connected to an electronic controller 36 that together make up a touch screen display 38, a switch 39, an auxiliary input/output (I/O) subsystem 40, a data port 42, a speaker 44, a microphone 46, short-range communications 48 and other device subsystems 50. The touch-sensitive overlay 34 and the electronic controller 36 provide a touch-sensitive input device and the main processor 22 may interact with the touch-sensitive overlay 34 via the electronic controller 36.

Some of the subsystems of the portable electronic device 20 may perform communication-related functions, whereas other subsystems may provide “resident” or on-device functions. By way of example, the display 32 and the touch-sensitive overlay 34 may be used for both communication-related functions, such as entering a text message for transmission over the network 1000, and device-resident functions such as a calculator or task list.

The portable electronic device 20 can send and receive communication signals over the wireless network 1000 after network registration or activation procedures have been completed. Network access may be associated with a subscriber or user of the portable electronic device 20. To identify a subscriber according to the present embodiment, the portable electronic device 20 may use a SIM/RUIM card 52 (i.e. Subscriber Identity Module or a Removable User Identity Module) inserted into a SIM/RUIM interface 54 for communication with a network such as the network 1000. The SIM/RUIM card 52 is one type of a conventional “smart card” that can be used to identify a subscriber of the portable electronic device 20 and to personalize the portable electronic device 20, among other things. In an embodiment the portable electronic device 20 may not be fully operational for communication with the wireless network 1000 without the SIM/RUIM card 52. By inserting the SIM/RUIM card 52 into the SIM/RUIM interface 54, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM/RUIM card 52 may include a processor and memory for storing information. Once the SIM/RUIM card 52 is inserted into the SIM/RUIM interface 54, it may be coupled to the processor 22. In order to identify the subscriber, the SIM/RUIM card 52 can include some user parameters such as an International Mobile Subscriber Identity (IMSI). An advantage of using the SIM/RUIM card 52 is that a subscriber is not necessarily bound by any single physical portable electronic device. The SIM/RUIM card 52 may store additional subscriber information for a portable electronic device as well, including datebook (or calendar) information and recent call information. Alternatively, user identification information can also be programmed into the flash memory 30.

The portable electronic device 20 may be a battery-powered device and may include a battery interface 56 for receiving one or more rechargeable batteries 58. In at least some embodiments, the battery 58 can be a smart battery with an embedded microprocessor. The battery interface 56 may be coupled to a regulator (not shown), which may assist the battery 58 in providing power V+ to the portable electronic device 20. Although current technology may make use of a battery, future technologies such as micro fuel cells may provide the power to the portable electronic device 20.

The portable electronic device 20 may also include an operating system 60 and software components 62 to 72 which are described in more detail below. The operating system 60 and the software components 62 to 72 that are executed by the main processor 22 are typically stored in a persistent store such as the flash memory 30, which may alternatively be a read-only memory (ROM) or similar storage element (not shown). Those skilled in the art will appreciate that portions of the operating system 60 and the software components 62 to 72, such as specific device applications, or parts thereof, may be temporarily loaded into a volatile store such as the RAM 28. Other software components can also be included, as is well known to those skilled in the art.

The subset of software applications 62 that control basic device operations, including data and voice communication applications, may typically be installed on the portable electronic device 20 during its manufacture. Other software applications may include a message application 64 that can be any suitable software program that allows a user of the portable electronic device 20 to send and receive electronic messages. Various alternatives exist for the message application 64 as is well known to those skilled in the art. Messages that have been sent or received by the user are typically stored in the flash memory 30 of the portable electronic device 20 or some other suitable storage element in the portable electronic device 20. In at least some embodiments, some of the sent and received messages may be stored remotely from the device 20 such as in a data store of an associated host system that the portable electronic device 20 communicates with.

The software applications can further include a device state module 66, a Personal Information Manager (PIM) 68, and other suitable modules (not shown). The device state module 66 may provide persistence, i.e. the device state module 66 ensures that important device data is stored in persistent memory, such as the flash memory 30, so that the data is not lost when the portable electronic device 20 is turned off or loses power.

The PIM 68 may include functionality for organizing and managing data items of interest to the user, such as, but not limited to, e-mail, contacts, calendar events, voice mails, appointments, and task items. A PIM application may have the ability to send and receive data items via the wireless network 1000. PIM data items may be seamlessly integrated, synchronized, and updated via the wireless network 1000 with the portable electronic device subscriber's corresponding data items stored and/or associated with a host computer system. This functionality creates a mirrored host computer on the portable electronic device 20 with respect to such items. This can be particularly advantageous when the host computer system is the portable electronic device subscriber's office computer system.

The portable electronic device 20 may also include a connect module 70, and an information technology (IT) policy module 72. The connect module 70 may implement the communication protocols that are required for the portable electronic device 20 to communicate with the wireless infrastructure and any host system, such as an enterprise system, that the portable electronic device 20 is authorized to interface with.

The connect module 70 may include a set of APIs that can be integrated with the portable electronic device 20 to allow the portable electronic device 20 to use any number of services associated with the enterprise system. The connect module 70 may allow the portable electronic device 20 to establish an end-to-end secure, authenticated communication pipe with the host system. A subset of applications for which access is provided by the connect module 70 can be used to pass IT policy commands from the host system to the portable electronic device 20. This can be done in a wireless or wired manner. These instructions can then be passed to the IT policy module 72 to modify the configuration of the device 20. Alternatively, in some cases, the IT policy update can also be done over a wired connection.

Other types of software applications can also be installed on the portable electronic device 20. These software applications can be third party applications, which are added after the manufacture of the portable electronic device 20. Examples of third party applications include games, calculators, utilities, etc.

The additional applications can be loaded onto the portable electronic device 20 through at least one of the wireless network 1000, the auxiliary I/O subsystem 40, the data port 42, the short-range communications subsystem 48, or any other suitable device subsystem 50. This flexibility in application installation may increase the functionality of the portable electronic device 20 and may provide enhanced on-device functions, communication-related functions, or both. For example, secure communication applications may enable electronic commerce functions and other such financial transactions to be performed using the portable electronic device 20.

The data port 42 may enable a subscriber to set preferences through an external device or software application and may extend the capabilities of the portable electronic device 20 by providing for information or software downloads to the portable electronic device 20 other than through a wireless communication network. The alternate download path may, for example, be used to load an encryption key onto the portable electronic device 20 through a direct and thus reliable and trusted connection to provide secure device communication.

The data port 42 can be any suitable port that enables data communication between the portable electronic device 20 and another computing device. The data port 42 can be a serial or a parallel port. In some instances, the data port 42 can be a USB port that includes data lines for data transfer and a supply line that can provide a charging current to charge the battery 58 of the portable electronic device 20.

The short-range communications subsystem 48 may provide for communication between the portable electronic device 20 and different systems or devices, without the use of the wireless network 1000. For example, the short-range communications subsystem 48 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download may be processed by the communication subsystem 24 and input to the main processor 22. The main processor 22 may process the received signal for output to the display 32 or alternatively to the auxiliary I/O subsystem 40. A subscriber may also compose data items, such as e-mail messages, for example, using the touch-sensitive overlay 34 on the display 32 that are part of the touch screen display 38, and possibly the auxiliary I/O subsystem 40. The auxiliary I/O subsystem 40 may include devices such as: a mouse, track ball, infrared fingerprint detector, or a roller wheel with dynamic button pressing capability. A composed item may be transmitted over the wireless network 1000 through the communication subsystem 24.

For voice communications, the overall operation of the portable electronic device 20 may be substantially similar, except that the received signals may be output to the speaker 44, and signals for transmission may be generated by the microphone 46. Alternative voice or audio I/O subsystems, such as a voice message recording subsystem, can also be implemented on the portable electronic device 20. Although voice or audio signal output may be accomplished primarily through the speaker 44, the display 32 can also be used to provide additional information such as the identity of a calling party, duration of a voice call, or other voice call related information.

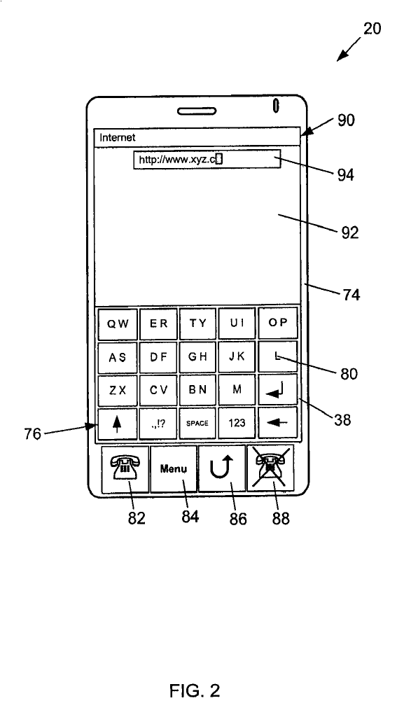

Reference is now made to FIG. 2, which shows a front view of an exemplary portable electronic device 20 in portrait orientation. The portable electronic device 20 may include a housing 74 that houses the internal components that are shown in FIG. 1 and frames the touch screen display or touch-sensitive display 38 such that the touch screen display 38 is exposed for user-interaction therewith when the portable electronic device 20 is in use. In the exemplary orientation shown in FIG. 2, the touch screen display 38 may include a portrait mode virtual keyboard 76 for user entry of data in the form of, for example, text during operation of the portable electronic device 20. It will be appreciated that such a virtual keyboard may be used for data entry in any suitable application such as in an electronic mail application, during electronic mail composition or in any other suitable application. The portrait mode virtual keyboard 76 of FIG. 2 may be provided for data entry in an Internet browser application and is shown as a reduced keyboard for exemplary purposes. The present disclosure is not limited to the portrait mode virtual keyboard 76 shown, as other keyboards including other reduced keyboards or full keyboards are possible. Suitable keyboards may include full or reduced QWERTY keyboards, full or reduced Dvorak keyboards, and other full or reduced keyboards, including keyboards adapted for non-English languages.

The touch screen display 38 can be any suitable touch screen display such as a capacitive touch screen display. A capacitive touch screen display 38 may include the display device, such as an LCD display 32 and the touch-sensitive overlay 34, in the form of a capacitive touch-sensitive overlay 34. It will be appreciated that the capacitive touch-sensitive overlay 34 may include a number of layers in a stack and may be fixed to the display 32 via a suitable optically clear adhesive. The layers can include, for example a substrate fixed to the LCD display 32 by a suitable adhesive, a ground shield layer, a barrier layer, a pair of capacitive touch sensor layers separated by a substrate or other barrier layer, and a cover layer fixed to the second capacitive touch sensor layer by a suitable adhesive. The capacitive touch sensor layers can be any suitable material such as patterned indium tin oxide (ITO).

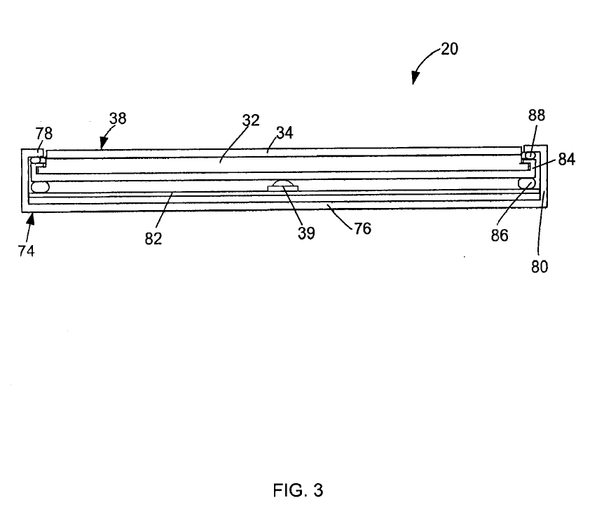

Reference is now made to FIG. 3, showing a simplified sectional side view of the portable electronic device of FIG. 2 (not to scale), with a switch shown in a rest position. As shown in FIG. 3, the housing 74 may include a back 76, a frame 78, which frames the touch-sensitive display 38, sidewalls 80 that extend between and generally perpendicular to the back 76 and the frame 78, and a base 82 that is spaced from and generally parallel to the back 76. The base 82 can be any suitable base and can include, for example, a printed circuit board or flex circuit board. The back 76 may include a plate (not shown) that is releasably attached for insertion and removal of, for example, the battery 58 and the SIM/RUIM card 52 described above. It will be appreciated that the back 76, the sidewalls 80 and the frame 78 can be injection molded, for example. In the exemplary portable electronic device 20 shown in FIG. 2, the frame 78 may be generally rectangular with rounded corners although other shapes are possible.

The display 32 and the touch-sensitive overlay 34 can be supported on a support tray 84 of suitable material such as magnesium for providing mechanical support to the display 32 and touch-sensitive overlay 34. The display 32 and touch-sensitive overlay 34 may be biased away from the base 82, toward the frame 78 by biasing elements 86 such as gel pads between the support tray 84 and the base 82. Compliant spacers 88, which can also be in the form of gel pads for example, may be located between an upper portion of the support tray 84 and the frame 78. The touch screen display 38 may be moveable within the housing 74 as the touch screen display 38 can be moved toward the base 82, thereby compressing the biasing elements 86. The touch screen display 38 can also be pivoted within the housing 74 with one side of the touch screen display 38 moving toward the base 82, thereby compressing the biasing elements 86 on the same side of the touch screen display 38 that moves toward the base 82.

In the present example, the switch 39 may be supported on one side of the base 82 which can be a printed circuit board while the opposing side provides mechanical support and electrical connection for other components (not shown) of the portable electronic device 20. The switch 39 can be located between the base 82 and the support tray 84. The switch 39, which can be a mechanical dome-type switch, for example, can be located in any suitable position such that displacement of the touch screen display 38 resulting from a user pressing the touch screen display 38 with sufficient force to overcome the bias and to overcome the actuation force for the switch 39, depresses and actuates the switch 39. In the present embodiment the switch 39 may be in contact with the support tray 84. Thus, depression of the touch screen display 38 by user application of a force thereto, may cause actuation of the switch 39, thereby providing the user with a positive tactile feedback during user interaction with the user interface of the portable electronic device 20. The switch 39 is not actuated in the rest position shown in FIG. 3, absent applied force by the user. It will be appreciated that the switch 39 can be actuated by pressing anywhere on the touch screen display 38 to cause movement of the touch screen display 38 in the form of movement parallel with the base 82 or pivoting of one side of the touch screen display 38 toward the base 82. The switch 39 may be connected to the processor 22 and can be used for further input to the processor when actuated. Although a single switch is shown any suitable number of switches can be used.

A touch event may be detected upon user touching of the touch screen display 38. Such a touch event can be determined upon a user touch at the touch screen display 38 for selection of, for example, a feature in a list, such as a message or other feature of for scrolling in the list or selecting a virtual input key. Signals may be sent from the touch-sensitive overlay 34 to the controller 36 when a suitable object such as a finger or other conductive object held in the bare hand of a user, is detected. Thus, the touch event may be detected and the X and Y location of the touch may be determined. The X and Y location of the touch may be determined to fall within the touch-sensitive area defined by the boundary on the touch screen display 38.

In the present example, the X and Y location of a touch event may be both determined with the X location determined by a signal generated as a result of capacitive coupling with one of the touch sensor layers and the Y location determined by the signal generated as a result of capacitive coupling with the other of the touch sensor layers. Each of the touch-sensor layers may provide a signal to the controller 36 as a result of capacitive coupling with a suitable object such as a finger of a user or a conductive object held in a bare hand of a user resulting in a change in the electric field of each of the touch sensor layers. The signals may represent the respective X and Y touch location values. It will be appreciated that other attributes of the user's touch on the touch screen display 38 can be determined. For example, the size and the shape of the touch on the touch screen display 38 can be determined in addition to the location (e.g., X and Y values) based on the signals received at the controller 36 from the touch sensor layers.

Referring still to FIG. 2, it will be appreciated that a user's touch on the touch screen display 38 may be determined by determining the X and Y touch location and user-selected input may be determined based on the X and Y touch location and the application executed by the processor 22. In the exemplary screen shown in the front view of FIG. 2, the application may provide the virtual keyboard 76 having a plurality of virtual input keys or buttons, which can be selected by the user. The user selected virtual input key may be matched to the X and Y touch location. Thus, the button selected by the user may be determined based on the X and Y touch location and the application. In the example shown in FIG. 2, the user may enter text via the virtual keyboard 76, selecting characters associated with the virtual input keys, such as letters from the virtual keyboard 76 by touching the touch screen display at the location of the letters, corresponding to the virtual input keys, of the virtual keyboard 76. In exemplary embodiments of the portable electronic device 20, the text or data entry may be accomplished by a “click to enter” operation. Once the user has selected a character, the character may be entered by depressing the virtual input key on the touch screen display 38 with sufficient force to overcome the bias of the touch screen display 38 and the actuation force of the switch 39, to cause movement of the touch screen display 38 and actuation of the switch 39. The selection of the virtual input key 80 (e.g., based on the X and Y location on the touch screen display) and the actuation of the switch 39 may result in signals that may be received by the main processor 22, thereby entering the corresponding character for rendering on the touch screen display. The “click to enter” operation may provide a tactile feedback confirming the entry to the user, thereby reducing the chance of inadvertent double entry requiring correction. This may also reduce the need for additional user interaction and use time thereby, reducing battery consumption. The click entry may also allow the user to touch the device and ensure the correct character is selected before entry of that character by clicking.

According to the present example as illustrated in FIG. 2, the main processor 22 may receive a user-selection of an Internet browser application for browsing the Internet by, for example, determination of a touch event at an Internet browser icon (not shown) displayed on the touch screen display 38.

For illustrative purposes, the virtual keyboard may be rendered in the portrait mode as shown in FIG. 2. Devices, such as accelerometers, can be used to determine the relative orientation of the portable electronic device 20 and change the orientation of the touch screen display accordingly. In the present example, the portrait mode virtual keyboard 76 may be a reduced QWERTY keyboard in which multiple alphanumeric characters and symbols may share virtual input keys or buttons 100. The virtual input keys or buttons 100 may be rendered with the alphanumeric characters and other keyboard buttons displayed in an upright position for the user. The portable electronic device 20 can be operated in any suitable mode for determining a user-desired one of the letters upon determination of a touch event at the respective one of the virtual input keys buttons 100 of the virtual keyboard 76. For example, letters can be selected using a single-tap mode, multi-tap mode, a text prediction mode or using any other suitable mode. The portable electronic device 20 according to the present example may also include four physical buttons 102, 104, 106, 108 in the housing 74 for user-selection for performing functions or operations including an “off-hook” button 102 for placing an outgoing cellular telephone call or receiving an incoming cellular telephone call, a Menu button 104 for displaying a context-sensitive menu or submenu, an escape button 106 for returning to a previous screen or exiting an application, and an “on-hook” button for ending a cellular telephone call. The remainder of the buttons shown on the face of the exemplary portable electronic device of FIG. 2 may be virtual buttons or input keys 100 on the touch screen display 38.

Along with the virtual keyboard, a display area may be rendered, which in the present example may be a portrait mode display area 90 that is a portrait mode Internet browser display screen 92. The display area may be provided in the portrait mode as a result of determination of the orientation at the accelerometer (not shown). The display area may be rendered above the portrait mode virtual keyboard 76 when the portable electronic device 20 is in the portrait orientation.

As a result of user touching any of the virtual buttons of the virtual keyboard and actuation of the switch 39, data input received from the virtual keyboard may be rendered in a data entry field 94 of the Internet browser display screen 92. As shown, input may be received in the form of user selection of characters including letters and symbols by touching ones of the virtual buttons 100 in the portrait mode virtual keyboard 76 and entry by actuation of the switch 39. In the example shown in FIG. 2, the user enters “http://www.xyz.c” and the data received may be displayed in the data entry field 94 of the portrait mode Internet browser display screen 92.

When entering data, the user may turn the portable electronic device 20 to a landscape orientation. A user may choose to turn the portable electronic device 20 to a different orientation to provide a different keyboard such as to change from a reduced keyboard to a full QWERTY keyboard as in the present example. In another example, the user may also choose to turn the portable electronic device 20 to provide a different display area for the application.

It should be noted that the present disclosure is not limited to virtual keyboards and can be applied to physical keyboards. Moreover, the present disclosure is not limited to portable electronic devices and could be applied to other electronic systems such as, for example, desktop computers.

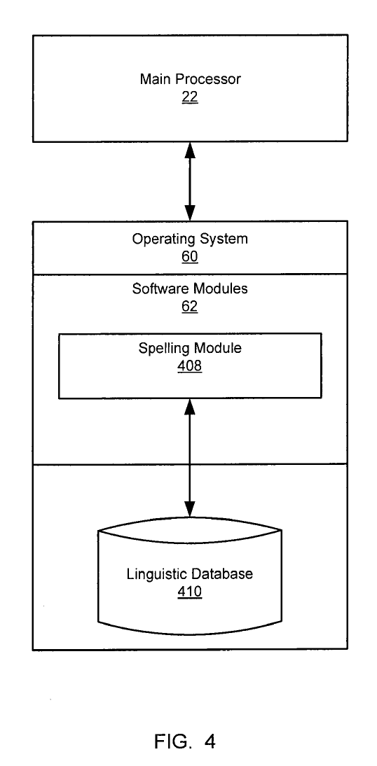

Reference is now made to FIG. 4, which shows a simplified block diagram of an example embodiment of the portable electronic device 20 suitable for implementing a key layout aware spell checking application. This block diagram is similar to that of FIG. 1, but has been simplified for ease of understanding. The main processor 22 may communicate with the operating system 60. The operating system 60 may include software modules 62, as described above. In particular, the software modules 62 may include a spelling module 408. In other example embodiments, the spelling module 408 may reside in the Random Access Memory (RAM) 28, the flash memory 30 or other subsystems.

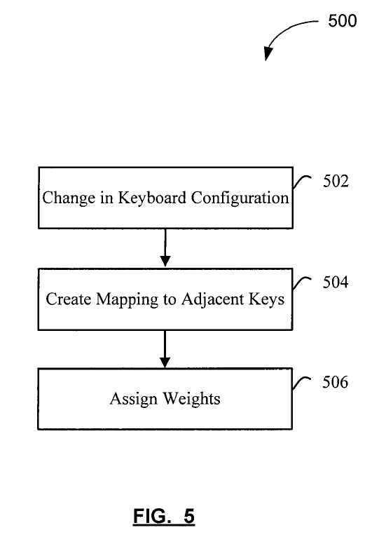

The spelling module 408 may have access to a linguistic database 410, such as a spelling database comprising known words and other strings. In some embodiments, the linguistic database 410 may comprise a generic word list. The linguistic database 410 may also include other information such as lists of common misspellings of known words, address book data, learning data, etc. The linguistic database 410 also comprises an adjacency mapping of each key on the keyboard 76 to adjacent keys. The adjacency mapping may also include a weight factor for each key/adjacent key pair indicating the likelihood that the key may be mistakenly entered instead of the adjacent key. The adjacency mapping will be discussed in further detail in relation to FIGS. 5-7C.

The spelling module 408 can be used to check strings entered by a user of the portable electronic device 20 using keyboard 76 and suggest alternative strings where, for example, the string doses not appear in linguistic database 410. These alternative strings may be prioritized such that alternative strings which are more likely to be the intended string are given a higher priority.

Thus, the portable electronic device 20 includes computer executable programmed instructions for directing the portable electronic device 20 to implement various applications. The programmed instructions may be embodied in the one or more software modules 62 resident in the memory 30 of the portable electronic device 20. Alternatively, the programmed instructions may be tangibly embodied on a computer readable medium (such as a DVD, CD, floppy disk or other storage media) which may be used for transporting the programmed instructions to the memory 30 of the portable electronic device 20. Alternatively, the programmed instructions may be embedded in a computer-readable, signal-bearing medium that is uploaded to the wireless network 1000 by a vendor or supplier of the programmed instructions, and this signal-bearing medium may be downloaded to the portable electronic device 20 from, for example, the wireless network 1000 by end users.

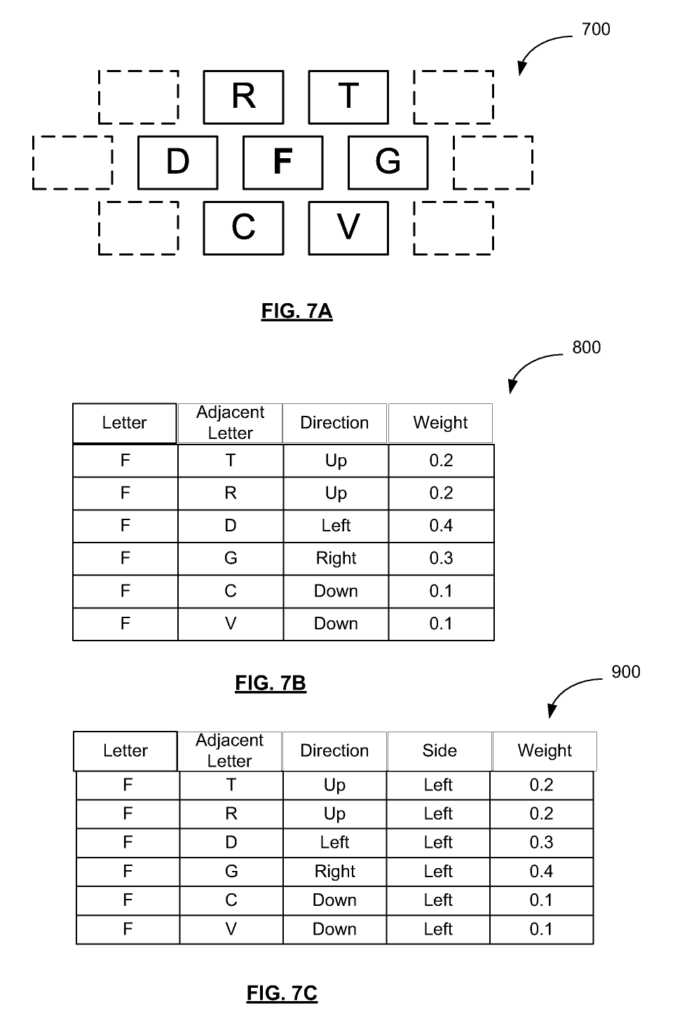

Reference is now made to FIG. 5, which shows a method 500 of creating an adjacency mapping in accordance with one embodiment. The method 500 is suitable for use in, for example, the portable electronic device 20 of FIG. 1. Reference will also be made to FIGS. 7A-7C where appropriate.

The method 500 can begin at block 502 where a change in the configuration of the keyboard 76 occurs. This may happen, for example, when there is a change in the orientation of the portable electronic device 20, as explained above, or when the user selects a different configuration for the keyboard 76. Some physical keyboards may also allow a user to change the configuration of its keys or, in some circumstances, a different keyboard with a different configuration may be connected to a computing device such as the portable electronic device 20 of FIG. 1.

A new keyboard configuration may be desired, for example, when a user wishes to input text in a different language or moves to a different location with a different standard keyboard configuration. For example, the user may wish to input a text in French which requires accents that do not appear on the standard English North American keyboard or the user may wish to input text in a language which uses a different alphabet, such as Chinese or Greek. Also, the standard keyboard configuration in some countries differs from the standard keyboard layout in North America, even where the same alphabet is used. When in a user is in such a jurisdiction, they may wish to change the layout of their personal keyboard 76 to match the local standard. As another example, the user may wish to use a specialized keyboard for certain tasks such as a keyboard which is specifically designed for data entry.

Block 502 may also be triggered when a device, such as the portable electronic device 20 of FIG. 1, is activated or initiated or when a new application, such as a spell checking application, is installed.

At block 504, an adjacency mapping is created to map each key in the keyboard to some or all of the adjacent keys. This can be done, for example, by creating a table similar to those shown in FIGS. 7B and 7C. For each key in the keyboard 76, an entry can appear in the table for each adjacent key such that a record is kept of all keys adjacent to each particular key. An example of a portion of a keyboard 700 is shown in FIG. 7A. In this example, the ‘F’ key has six keys adjacent to it, namely the ‘R’, ‘T’, ‘D’, ‘G’, ‘C’, and ‘V’ keys. FIG. 7B shows an example table 800 giving a simple adjacency mapping for the ‘F’ key from the keyboard portion 700 shown in FIG. 7A. The table 800 includes one entry for each of the letters adjacent to the ‘F’ key in the keyboard portion 700. In some embodiments, the adjacency mapping may be stored using an adjacency matrix.

When a spelling error has been detected in a string inputted by a user, alternative strings representing known strings in linguistic database 410 may be presented to the user. For example, if a user were to input the string ‘thuf’ which does not appear in the linguistic database 410, the strings ‘thus’, ‘thud’ and ‘thug’ might be presented to the user as alternative strings. Those skilled in the art will recognize that there are many known methods for creating a list of alternative strings for an erroneously inputted string. Many known applications, such as Microsoft Word™ and Microsoft Entourage™, provide this function.

When a key is mistyped, it may be likely that the intended key is, in many cases, adjacent to the key which was selected by the user. This may be particularly true where the keys of the keyboard 76 are close together, such as when the keyboard 76 appears on a portable electronic device 20. Thus, in determining the likelihood that an alternative string was the intended string, the adjacency mapping can help prioritize the alternative strings by giving higher priority to those strings which differ from the intended string by letters where the key for a letter in the alternative string is adjacent to the key for the corresponding letter in the inputted string.

The adjacency mapping may also include a weight for each key/adjacent key pair. At 506, this weight information may be determined and assigned to each key/adjacent key pair. The weight can represent the likelihood that the adjacent key was the key that the user intended to select instead of the selected key. For example, it may be more likely that a user will have intended to select a key above the selected key rather than a key below the selected key. In this case, the adjacent keys above the selected key can be given a higher weight than the adjacent keys below the selected key in the adjacency mapping. For example, in the exemplary simple adjacency mapping 800 shown in FIG. 7B, the table entry for each key adjacent to the ‘F’ key includes a field indicating the direction of the key from the ‘F’ key on the keyboard portion 700 shown in FIG. 7A. In this example, it has been determined that keys to the left of a selected key are more likely to be the intended key than keys to the right of a selected key. Hence, the ‘D’ key, which is to the left of the ‘F’ key, has a greater weight than the ‘G’ key, which is to the right of the ‘F’ key. Continuing the example from above, suppose a user inputs the string ‘thuf’ using the keyboard 76 resulting in alternative strings ‘thus’, ‘thud’ and ‘thug’. Alternative string ‘thud’ may be given a higher priority than alternative string ‘thug’ because the ‘D’ key is to the left of the ‘F’ key on the keyboard portion 700 of FIG. 7A (giving it a weight of 0.4) and the ‘G’ key is to the right of the ‘F’ key (giving it a weight of 0.3).

The weights assigned to key/adjacent key pairs may be based, for example, on knowledge regarding the prevalence of mistyped keys in the general population, knowledge regarding the prevalence of mistyped keys within a specific group of users or they may be based on the history of mistyped keys for the current user. The weights may also take into account attributes of the keyboard 76 currently in use. For example, if keys on the keyboard 76 are very close to the keys adjacent to the left and right but not as close to those above or below them, keys adjacent to the left and right may be given higher weight to account for this.

In some embodiments, calibration data is taken into account in assigning the weights. For example, a user may be presented with a phrase to type. As the user types the phrase using, for example, a virtual keyboard, the coordinates where each key is selected or actuated may be noted. Since the intended key is known, this data can be used to calculate how much the user's finger is slipping from the target zone for selecting or actuating the intended key, and this information can be taken into account in assigning the weight factor.

In some embodiments, the adjacency mapping may also include information about each key's location on the keyboard for use in determining the weight to be given to adjacent keys. For example, each entry in the adjacency mapping may include a field indicating whether the key appears on the left or right hand side of the keyboard 76. This information may be incorporated into the process of assigning the weights. For example, a user may be more likely to mistype keys to the left of a target key when using their right hand but more likely to mistype keys to the right of a target key when using their left hand. In this case, keys placed on the right hand side of the keyboard 76 may have a higher weight for keys adjacent to the left of a selected key than to the right of a selected key and vice versa for keys appearing on the right hand side of a keyboard 76. FIG. 7C shows a portion of an exemplary adjacency mapping table 900 for the ‘F’ key from the keyboard portion 700 of FIG. 7A. The adjacency mapping table 900 includes a column indicating that all the keys adjacent to the ‘F’ key are on the left hand side of the keyboard 76. In this example, the weights of the ‘D’ and ‘G’ keys have been changed to account for the location of the keys on the keyboard 76.

In some embodiments, the keyboard 76 may include shared keys such as with the keyboard 76 shown in FIG. 2. This may also be taken into account when the adjacency mapping is created.

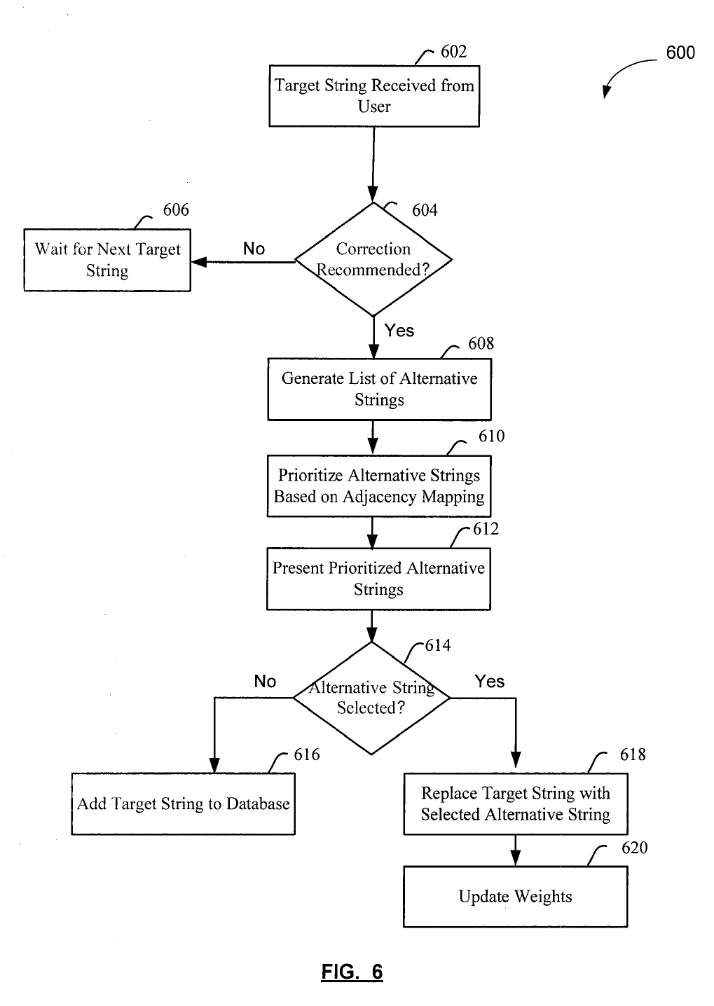

Reference is now made to FIG. 6, which shows a method 600 of presenting a prioritized list of alternative strings in accordance with one embodiment. The method 600 is suitable for use in, for example, the portable electronic device 20 of FIG. 1. Reference will also be made to FIGS. 2 and 7A-7C where appropriate.

The method 600 can begin at block 602 where a target string is received from a user. For example, a user may have entered the string using a keyboard 76 on, for example, a portable electronic device 20. The target string may be a full string, such as a full word. Alternatively, method 600 may proceed for partial strings, such as partial words which the user has not yet completed. For example, in some embodiments, method 600 may be invoked each time a user adds or modifies a character in a string which is in the process of being entered.

At 604, the target string is checked to determine if a correction to the string is recommended. In other words, it is determined whether it is likely that the string was mistyped. For example, the target string may be checked against a linguistic database 410. If it is determined that no correction is required, for example if the target string appears in the linguistic database 410, then the method 600 proceeds to block 606 to wait for a new target string. It will be understood by those skilled in the art that other criteria may be taken into account when it is determined whether a correction is recommended. For example, in some embodiments, no correction may be recommended for proper nouns or for strings which comprise numeric values. In some embodiments, no correction may be recommended based on user settings. For example, if a spell checking application is set to be case insensitive then no correction may be recommended for the word “august” even though the word should be capitalized. Also, in some embodiments, no correction may be recommended for strings from language scripts other than the current device input language.

If it is determined that a correction is recommended, the method 600 proceeds to block 608 where a list of alternative strings is generated. These alternative strings may represent known words or other text which are likely to be a string which the user may have intended to enter. For example, a target string may be a common misspelling of an alternative string. The process of generating a list of alternative strings is well known in the art of spell checking applications and those of skill in the art will recognize that there are many ways of generating a list of alternative strings.

At 610, the alternative strings are prioritized based on the adjacency mapping which maps each key in the keyboard to some or all of the adjacent keys. As explained above, alternative strings which differ from the target string by one or more characters whose keys are adjacent may be given a higher priority. Also as explained above, the adjacency mapping may also include one or more weights which may be factored into the prioritization.

For example, a user may input the string ‘thuf’ using a keyboard 76, a portion of which is shown in FIG. 7A. A list of alternative strings comprising ‘thus’, ‘thud’ and ‘thug’ may be generated at 608. At 610, alternative string ‘thud’ may be given a higher priority than alternative string ‘thug’ because the ‘D’ key is to the left of the ‘F’ key on the keyboard portion 700 of FIG. 7A, giving it a weight of 0.4, and the ‘G’ key is to the right of the ‘F’ key, giving it a weight of 0.3 according to the adjacency mapping 800 shown in FIG. 7B. Alternative string ‘thus’ may be given the lowest priority of the three example alternative strings because the ‘S’ key is not adjacent to the ‘F’ key on the keyboard portion shown in FIG. 7A.

Those of skill in the art will recognize that there may be numerous ways of combining information from the adjacency mapping, possibly along with other information, to determine a priority for each of the alternative strings. For example, information regarding the frequency of each of the alternative strings could be combined with information from the adjacency mapping to determine the priority of each string. In some embodiments, shared keys, as mentioned above, may be taken into account as well as keys that differ only by accents.

At 612, the priority information for the alternative strings may be used to determine in which alternative strings will be presented to the user and/or the order which alternative strings will be presented to the user. For example, only the x number of strings with the highest priority or only strings with a priority above a predetermined level may be presented to the user. Similarly, the alternative strings presented to the user may be sorted according to priority. The alternative strings may be presented, for example, on the display 32 of the portable electronic device 20 of FIG. 1. Alternatively, in some embodiments, the inputted string may automatically be replaced with the highest priority alternative string without presenting any alternative strings to the user.

Once the prioritized alternative strings have been presented to the user at 612, the user may select one of the alternative strings using, for example, the keyboard 76 of the portable electronic device 20 shown in FIG. 1. At 614, it is determined whether one of the alternative strings has been selected by the user.

If the user does not accept one of the alternative strings, the method 600 proceeds to 616. At 616, if the user decides to keep the target string as is, optionally, the target string may be added to the linguistic database as a string which the user considers to be correct. In some embodiments, the user may be asked to confirm that the target string should be added to the linguistic database before this step is taken. If the user decides not to accept one of the alternative strings and enters a new target string, the method 600 may begin again at step 602 with the new target string.

If the user does accept one of the alternative strings, at 618, the target string may be replaced by the selected alternative string.

As explained above, weights assigned to key/adjacent key pairs in the adjacency mapping may be based, for example, on knowledge regarding the prevalence of mistyped keys in the general population, within a specific group of users or they may be based on the history of mistyped keys for the current user. If the weights are based, at least in part, on the history of mistyped keys for the current user then, at 620, the adjacency mapping may optionally be updated to take into account information about the current target string and selected alternative string. For example, if the target string was ‘thuf’ and the selected alternative string was ‘thug’ then the weight for the adjacent letter ‘G’ in the adjacency mappings 800 and 900 shown in FIGS. 7B and 7C, respectively, could be increased and/or the weight for each of the other adjacent keys could be lowered accordingly. Individual weight factors can also be propagated back to the server to provide a better average starting weight factors based on, for example, language, industry and gender.

While the embodiments of methods 500 and 600 comprise blocks or steps shown as occurring in a particular order, it will be appreciated by those skilled in the art that many of the blocks are interchangeable and may occur in different orders than that shown without materially affecting the end results of the methods 500 and 600.

The embodiments of the present disclosure described above are intended to be examples only. Those of skill in the art may effect alterations, modifications and variations to the particular embodiments without departing from the intended scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A system comprising:
a processor for controlling operation of the system;
a memory coupled to the processor;
at least one output device coupled to the processor; and
a keyboard configured to provide input to the processor for receiving a target string comprising characters;
the memory including one or more modules for providing one or more prioritized alternative strings for a target string, the one or more modules being configured to cause the processor to:
maintain an adjacency mapping from each key on the keyboard to each adjacent key;
determine whether a correction is recommended for the target string; and
if a correction is recommended for the target string, present the one or more prioritized alternative strings on the at least one output device,
wherein the one or more prioritized alternative strings are prioritized based on the adjacency mapping.

2. The system of claim 1, wherein the keyboard is a virtual keyboard.

3. The system of claim 1, wherein the adjacency mapping further includes a weight factor between a target key and each key adjacent to the target key.

4. The system of claim 3, wherein the weight factor between the target key and the key adjacent to the target key represents the likelihood that the target key was mistakenly typed instead of the key adjacent to the target key.

5. The system of claim 4, wherein the likelihood that the target key was mistakenly typed instead of the key adjacent to the target key is based on a history of user mistakes.

6. The system of claim 5, wherein the history of user mistakes is maintained for each individual user.

7. The system of claim 5, wherein the system is further configured to receive a selected alternative string, replace the target string with the selected alternative string and update the history of user mistakes.

8. The system of claim 5, wherein the likelihood that the target key was mistakenly typed instead of the key adjacent to the target key is further based on the location of the target key on the keyboard.

9. The system of claim 1, wherein maintaining an adjacency mapping comprises updating the adjacency mapping upon reconfiguration of the keyboard.

10. The system of claim 1, wherein the system comprises a portable electronic device.

11. A method of providing one or more prioritized alternative strings for a target string in a text inputted by a keyboard, the method comprising:
maintaining an adjacency mapping for each key on the keyboard to each adjacent key;
receiving the target string;
determining whether a correction is recommended for the target string; and
if a correction is recommended for the target string, presenting the one or more prioritized alternative strings,
wherein the one or more prioritized alternative strings are prioritized based on the adjacency mapping.

12. The method of claim 11, wherein the keyboard is a virtual keyboard.

13. The method of claim 11, wherein determining whether a correction is recommended for the target string comprises determining whether the target string appears in a linguistic database.

14. The method of claim 11, wherein the adjacency mapping further includes a weight factor between a target key and each key adjacent to the target key.

15. The method of claim 14, wherein a weight factor between the target key and the key adjacent to the target key represents the likelihood that the target key was mistakenly typed instead of the key adjacent to the target key.

16. The method of claim 15, wherein the likelihood that the target key was mistakenly typed instead of the key adjacent to the target key is based on a history of user mistakes.

17. The method of claim 16, wherein the history of user mistakes is maintained for each individual user.

18. The method of claim 16, wherein the method further comprises receiving a selected alternative string, replacing the target string with the selected alternative string and updating the history of user mistakes.

19. The method of claim 11, wherein the likelihood that the target key was mistakenly typed instead of the key adjacent to the target key is further based on the location of the target key on the keyboard.

20. The method of claim 11, wherein maintaining an adjacency mapping further comprises updating the adjacency mapping upon reconfiguration of the keyboard.
